(19) United States
(12) Patent Application Publication
(10) Pub. No.: US 2012/0182549 A1
(43) Pub. Date: Jul. 19, 2012

(54) LIGHT SOURCE WITH UNIFORM CHROMATICITY AND LUMINANCE AND COLOR SENSOR PROVIDED WITH SAME

(75) Inventors: Tsung-I Wang, Kuei-Shan Hsiang (TW); Ching-Jang Feng, Kuei-Shan Hsiang (TW); Lan-Sheng Yang, Kuei-Shan Hsiang (TW)

(73) Assignee: CHROMA ATE INC., Kuei-Shan Hsiang (TW)

(21) Appl. No.: 13/349,362

(22) Filed: Jan. 12, 2012

(30) Foreign Application Priority Data
Jan. 14, 2011 (TW) 100101411

(51) Int. Cl. G01J 3/46; F21V 8/00

(52) U.S. Cl. 356/300; 362/612

(57) ABSTRACT

The present invention discloses a light source with uniform chromaticity and luminance and a color sensor having the same. The light source includes multiple LED devices, a primary light guide plate assembly and a secondary light guide plate assembly. The chromaticity and luminance of light emitted from the LED devices are uniformized for the first time in the primary light guide plate assembly and then guided into the secondary light guide plate assembly for the secondary chromaticity and luminance uniformization, to thereby act as the light source of the color sensor. Therefore, the light source not only provides better chromaticity and luminance uniformization effects, but is further qualified as the standard illuminant D65, thereby enabling more precise color sensor inspection results.

### BACKGROUND OF THE INVENTION

1. Field of the Invention

The present invention generally relates to a light source and, more particularly, to a light source with uniform chromaticity and luminance and a color sensor equipped with the same.

2. Description of Related Art

The perception on color of an object in human eyes is created by means that visible light illuminates on the surface of the object, and the diffused light reflected from the surface of the object activates and stimulates the retinal cone cells which are responsible for color sensitization and convert such photo stimulations into electric signals to the cerebral visual sensory area for judgment thereby generating color perception and identifying the color of the object. Although wavelength range of visible light may vary for different persons, it generally encompasses the spectrum band of 400˜750 nm.

The processes of color perception for human beings are related with factors like the light source, the illuminated object's surface and the observer's color recognition, rather than entirely depending on the illuminated object alone. When setting forth a quantitative and objective description on the color that an object exhibits, the influence caused by the light source has to be considered even with exclusion of uncontrollable observer variations. In order to eliminate the interferential factor of light source differentiation and unify the definition on colors, the International Commission on Illumination (CIE) has stipulated many specifications concerning standard illuminants and standard light sources, such as standard illuminant A, standard illuminant D and standard light source A, and so on. Among such, the standard light source A can be implemented through an incandescent light bulb filled with halogen gas which features low manufacture costs and simple fabrication processes, but defects like short lifespan and reduced illumination efficiency prove itself to be a non-ideal and non-economical light source.

A sort of chromatic aberration sensor available in market is shown in FIG. 1, which adopts a light source composed of a Xeon lamp 11 in conjunction with filters and generally conforms to the standard illuminant D65 specification. In order to satisfy the requirements on luminance and chromaticity uniformities, it is further provided with an integrating sphere 1 having a diameter of approximately 15 centimeters for light mixing. The total area of the opening on the integrating sphere 1 is far less than the total surface area of the integrating sphere, and the area of the light exit hole 13 is about twice as large as the area of the light entry hole 12. The illumination area that this device can provide is a circular area of about 10 mm diameter. The uniformity of the light block at the light exit hole 13 is greater than 98%, with the color rendering index thereof being slightly higher than 90. However, since this type of light source can not fully match the standard D65 spectrum distribution, it can be merely applied as a chromatic aberration sensor for inspecting the relative color of an object under test (OUT) rather than used as an accurate color sensor.

Especially, to expand the inspection range, it is required to enlarge the area of the light exit hole. In other word, the size of the integrating sphere needs to be increased. To enlarge the measurable area to a diameter of 200 mm, it needs to use a sphere of 400 mm diameter which may lead to a huge sphere size and accordingly a voluminous equipment, so the costs of the integrating sphere is also significantly elevated while light utilization efficiency thereof can be merely about 10%, unacceptable for industrial production demands.

Comparatively, a light emitting diode (LED) will offer advantages of high illumination efficiency, long lifespan and the like and, thus, is suitable to be used as the light source. The drawbacks thereof are unable to cover the entire range of visible light due to its narrow emission spectrum. A white-light LED device, which is formed by a combination of blue light LED chip and yellow fluorescent powder or by a combination of red, green and blue light LEDs, may deceive human eyes that make people believe they are watching white light, but by delving into the spectrum distribution thereof, it cannot satisfy the definition of CIE standard illuminant.

At preset, numerous types of LED illumination materials adapted to emit various wavelengths of light are available. It is applicable to consider combining different single-color narrow-band sources of light and, by way of a suitable light mixing mechanism, to synthesize a simulated light source which meets the CIE definition for standard illuminants, herein referred to as the “standard illuminant simulation light”. Since the “standard illuminant simulation light” genuinely conforms to the CIE definition of standard illuminant, it can be applied as the light source for chromaticity measurement of an object.

In addition to the necessary conformance to standard illuminant in terms of spectrum distribution, the “standard illuminant simulation light” obtained by combining multiple single-color LEDs also needs to be capable of providing a light block with more than 98% and 95% uniformity in chromaticity and luminance, respectively, over a given applied area. As such, it may require more than 20 different specifications of LEDs to achieve the “standard illuminant simulation light,” as measured by spectrum matching simulations based on the LEDs currently available in market.

Therefore, to develop an effective light mixing for a large amount of LEDs also becomes an issue to be resolved. In the conventional technologies of mixing multiple light sources of different colors, the optical architecture commonly used in projector applications is to progressively add different light sources into the main light beam by means of dichroic mirrors (DMs), thereby integrating respective light components to constitute the required light source. Nonetheless, on one hand, as the number of added light components increases, the light components added earlier may face a more adverse attenuation due to gradual absorptions and reflections when passing through many dichroic mirrors, thus leading to lowered utilization efficiency of light. On the other hand, all of the dichroic mirrors need be arranged in perfectly parallel manner, so as to achieve a collimated exit light. Hence, this commonly used optical architecture does not meet the requirement of the invention.

Another typical light mixing architecture involves utilization of light guide plates. For example, in currently available display devices, it is common to use red-, green- and blue-light LEDs together as a light source in a backlight plate and, by means of a light guide plate, mix and covert the light emitted from the lateral side into a surface light source. The light guide plates of this type are made of acrylic material. As shown in FIG. 2, the light guide plate is normally divided into two sections: the front section being the light mixing zone, while the later one being referred as the light exit zone. The light guide plate exploits the feature that total reflection may occur at a certain specific angle when light travels from a medium of high refractive index to a medium of low refractive index, such that light beams may advance and diffuse with extremely low loss thereby achieving the objective of uniform light mixing. Furthermore, a specific surface may be textured to interfere with the total reflection of light in the medium, such that light beams can leave the light guide plate. For illustration purpose, the specific surface is defined herein as the light exit face.

However, since the light beams emitted from the blue-light LED 21 and the red-light LED 22 are both of Lambertian distribution, with the intensity of the light beams at respective divergent angles being a function of cos θ, a “space effect” may be induced due to different installation locations. The light block after mixing may become bluish in the area near the LED 21 and reddish in the area close to the LED 22, causing significant color non-uniformity in the light exit zone 230 and resulting in poor light mixing effect by using this optical structure. In the case of a display device, a diffusion plate is disposed in front of the light guide plate to further uniformize the exit light. Besides, human eyes may not be so strictly demanding with regards to light uniformity. In particular, since a liquid crystal module is mounted in front of the back light plate, even though the backlight source is indeed non-uniform, it is still possible to perform reverse compensation through modulation of liquid crystal light valves, such that the color appearance in the displayed image can be successfully restored back to an original level that viewers cannot perceive any trace of color non-uniformity. Also, since LEDs in a backlight source normally comprise alternately arranged red-, green- and blue-light LEDs, the highly repeated structure, in which each of the LEDs provides only a tiny quantity of light components, makes the possible non-uniformity caused by a non-uniform light mixing hardly be noticed.

However, the optical structure described above can hardly applied to a color sensor, in which more colors of light have to be mixed and the repeated occurrences for the LEDs of a given color are less and, thus, a non-uniformity caused by light mixing may become harder to be mutually compensated. Moreover, in a color sensor, light is directly illuminated onto the OUT from the light source without liquid crystal light valves or other elements interposed in-between. Therefore, the non-uniformity in the exit light cannot be eliminated through such devices. Seeing that a slight non-uniformity may result in a failure of the light projected onto the OUT to be qualified as a CIE standard illuminant and to achieve accurate measurement results. The optical structure described above is not an ideal light source for the invention.

Therefore, it would be a critical issue for producing the light source of a color sensor, which is capable of mixing the light emitted from multiple LEDs having different central spectra in a more uniform manner. As a result, the light source disclosed herein is perfectly qualified as a CIE standard illuminant, and a LED spot light source is expended to a surface light source with uniform chromaticity and luminance.

### SUMMARY OF THE INVENTION

An objective of the present invention is to provide a light source with uniform chromaticity and luminance.

Another objective of the present invention is to provide a light source, which is so uniform in chromaticity and luminance as to be qualified as a CIE standard illuminant.

Yet another objective of the present invention is to provide a light source, which is so uniform in chromaticity and luminance as to be applicable as a light source for a color sensor.

Still another objective of the present invention is to provide a light source with uniform chromaticity and luminance, in which the area of the light exit face can be conveniently expanded.

Yet still another objective of the present invention is to provide a color sensor comprising a light source with uniform chromaticity and luminance.

Yet still another objective of the present invention is to provide a color sensor comprising a light source with uniform chromaticity and luminance, which can measure a large-sized object under test without significant increase in manufacture costs.

The present invention therefore provides a light source with uniform chromaticity and luminance comprises: a plurality of light emitting diode (LED) devices, having at least two mutually different central wavelengths; a primary light guide plate assembly, including a downstream primary light guide plate having a light entry face and a light exit face adjacent to the light entry face, in which a light exit zone is formed on the light exit face of the downstream primary light guide plate; and a secondary light guide plate assembly, including a plurality of mutually stacked secondary light guide plates, in which each of the secondary light guide plates has a light entry face and a light exit face adjacent to the light entry face, and the light entry faces of the secondary light guide plates exactly correspond to the light exit zone of the downstream primary light guide plate.

A color sensor fabricated by using the aforementioned light source with uniform chromaticity and luminance according to the invention is adapted to measure color components in a reflected light from an object under test (OUT) upon illumination. The color sensor comprises a light source with uniform chromaticity and luminance. The light source includes a plurality of light emitting diode (LED) devices, having at least two mutually different central wavelengths; a primary light guide plate assembly, including a downstream primary light guide plate having a light entry face and a light exit face adjacent to the light entry face, in which a light exit zone is formed on the light exit face of the downstream primary light guide plate; and a secondary light guide plate assembly, including a plurality of mutually stacked secondary light guide plates, in which each of the secondary light guide plates has a light entry face and a light exit face adjacent to the light entry face, and the light entry faces of the secondary light guide plates exactly correspond to the light exit zone of the downstream primary light guide plate. The color sensor further comprises a splitter device for separating respective wavelength components in the light diffused from the OUT illuminated by the light source with uniform chromaticity and luminance; and a sensor device for detecting the intensity of the respective wavelength components separated by the splitter device.

The architecture of the light source according to the invention involves installing multiple LED devices having mutually different central wavelengths to the light entry face of the primary light guide plate assembly, and at the same time, utilizing the last piece of the primary light guide plates in the primary light guide plate assembly as the downstream primary light guide plate and using the light exit face thereof as the light exit face of the primary light guide plate assembly. Subsequently, the secondary light guide plates in the secondary light guide plate assembly are installed such that the light entry faces thereof correspond to the light exit face of the primary light guide plate assembly, thereby receiving the exit light from the primary light guide plate assembly for secondary light mixing.

Since the primary light guide plate assembly is composed of multiple primary light guide plates, the light entry face can accommodate more LED devices. This facilitates implementation of intensity elevation by adding a greater number of LED devices or otherwise conformance to the D65 specification through installment of multiple LED devices having different central wavelengths. Meanwhile, by way of two light-mixing processes for mixing light along substantially vertical directions, the problem of insufficient uniformity in the exit light from the primary light guide plate assembly can be significantly overcome and, thus, the chromaticity and the luminance of the integral exit light can be completely uniformized, thereby achieving all of the objectives described above.

### BRIEF DESCRIPTION OF THE DRAWINGS

FIG. 1 shows a schematic view of a conventional chromatic aberration sensor;

FIG. 2 shows a schematic perspective view of a conventional light guide plate;

FIG. 3 shows a schematic view for a light source with uniform chromaticity and luminance according to the first preferred embodiment of the invention;

FIG. 4 shows a schematic view for the secondary light guide plate assembly in the light source of FIG. 3;

FIG. 5 is a photograph showing a light block image with confirmed chromaticity uniformity, which is captured after light mixing by a conventional primary light guide structure.

FIG. 6 is a photograph showing a light block image with confirmed chromaticity uniformity, which is captured after light mixing by the secondary light guide plate assembly according to the invention;

FIG. 7 is a graph comparing the difference in uniformity between the captured images of FIGS. 5 and 6;

FIG. 8 is a graph showing a result of observing the uniformity obtained after light mixing by the secondary light guide plate assembly by taking 20 points from the image of FIG. 6;

FIG. 9 shows a schematic view of a color sensor according to the first preferred embodiment of the invention, which is provided with the light source of FIG. 3;

FIG. 10 shows a schematic view of a light source according to the second preferred embodiment of the invention;

FIG. 11 shows a schematic view of a color sensor according to the second preferred embodiment of the invention; and

FIG. 12 shows a schematic view for a color filter wheel mounted in the color sensor of FIG. 11.

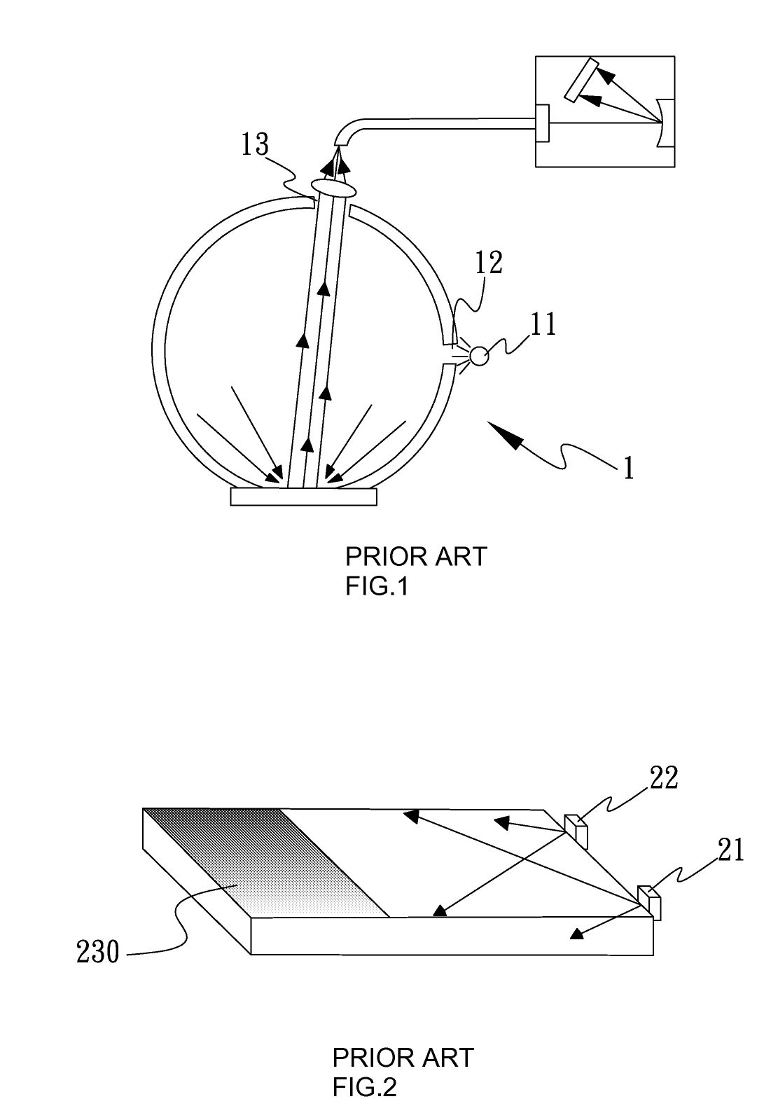

### DETAILED DESCRIPTION OF THE PREFERRED EMBODIMENTS

The aforementioned and other technical contents, aspects and effects in relation with the present invention can be clearly appreciated through the detailed descriptions concerning the preferred embodiments of the present invention in conjunction with the appended drawings.

In order to make the spectrum distribution qualified as a CIE standard illuminant, the invention applies multiple LED devices having different spectra, appropriately in conjunction with several narrow-band light sources with different central wavelengths and through a light mixing mechanism of light guide plates, to synthesize the “standard illuminant simulation light” that satisfies the CIE standard and serves as a light source useful for measurement of the chromaticity of an object. The measurement on the color of an object in accordance with the CIE 1931-(X, Y, Z) chromaticity system can be expressed as the following simple equation:

W=∫₃₈₀⁷⁸⁰S·R· w̅dλ; W=X,Y,Z; w̅= x̅, y̅, z̅

In this equation, S indicates the illumination light, R means the surface reflectance of an OUT and w̅ indicates the color matching function, whereas all of which are functions of wavelength. From this equation, it can be appreciated that the spectrum distribution in the illumination light will directly influence the results of tri-stimulus values (X, Y, and Z). Hence, being a projection light block of a colorimeter or a color sensor, the uniformity in both color mixing and light mixing on an effective area need to fulfill a particular specification.

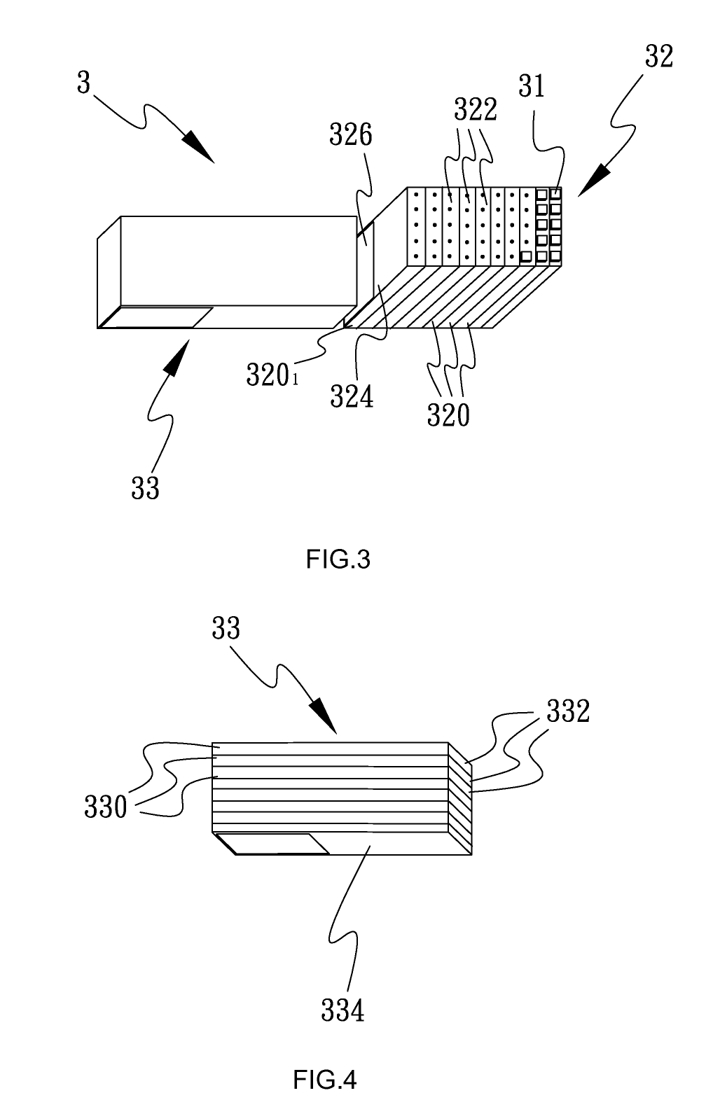

To make the simulated light source resemble closely to the standard light source, a light source 3 according to the invention, as shown in FIG. 3, comprises a plurality of LED devices 31, a primary light guide plate assembly 32 and a secondary light guide plate assembly 33. In the present embodiment, the primary light guide plate assembly 32 is constructed based on a multi-piece stacked architecture, in which multiple light guide plates 320 are stacked in the same geometric direction to constitute a cube. Therefore, the light entry face thereof is expanded, thereby satisfying the need for accommodating a great number of LED devices. Each of the primary light guide plates 320 includes a light entry face 322 and a light exit face 324 adjacent to the light entry face 322, with a light exit zone 326 being formed on the light exit face 324. The respective primary light guide plates 320 are of a rectangular structure and are stacked in a manner that the light exit faces 324 thereof are arranged in parallel. For the purpose of illustration, the primary light guide plate 320 whose light exit face is located at the outmost side in the stack is herein defined as the downstream primary light guide plate 320₁.

Next, referring conjunctively to FIG. 4, the secondary light guide plate assembly 33 in the present embodiment is of a cuboid structure formed by stacking a plurality of secondary light guide plates 330. Similarly, each of the secondary light guide plates 330 includes a light exit face 334 and a light entry face 332 having a surface area smaller than the light exit face 334. Besides, the light entry faces 332 of the secondary light guide plates 330 are arranged co-planar to one another, and the total surface area of the light entry faces 332 is approximately equal to that of the light exit zone 326 of the downstream primary light guide plate 320₁, such that, upon combining the secondary light guide plate assembly 33 with the primary light guide plate assembly 32, the light mixed within the primary light guide plate assembly 32 virtually completely enters into the secondary light guide plate assembly 33 for secondary light mixing without significant energy loss.

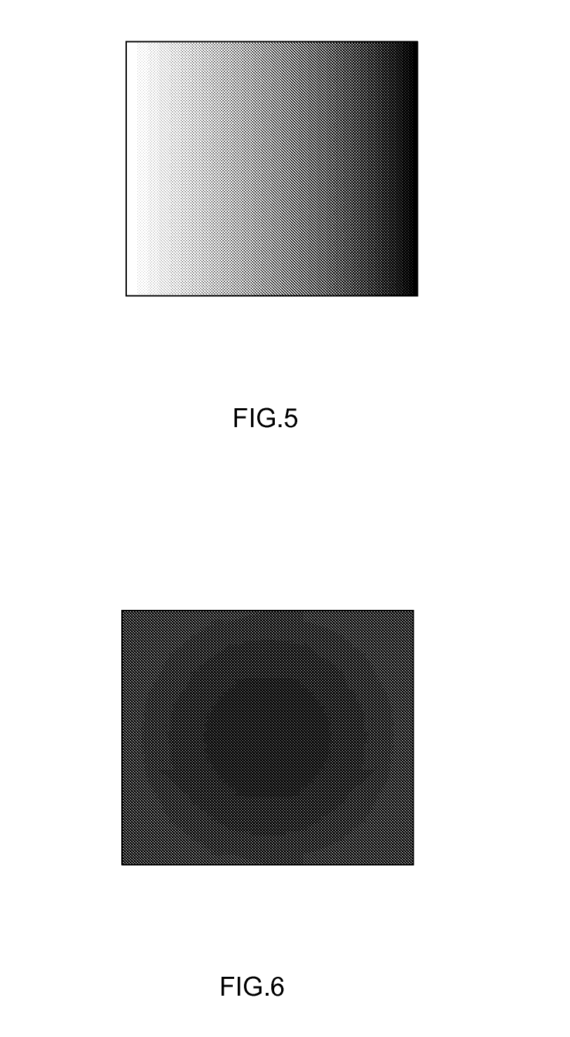

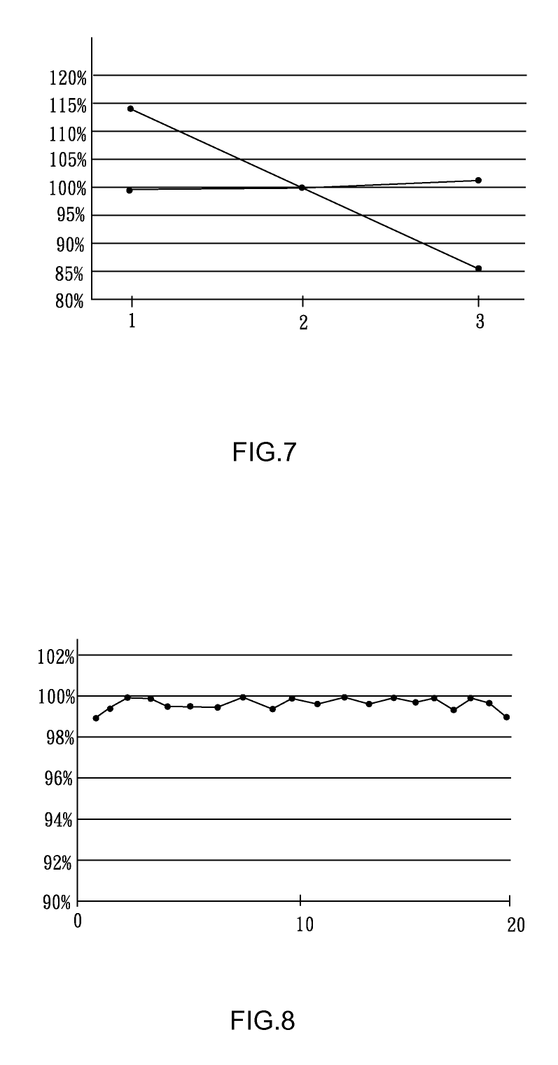

In order to clearly illustrate the improvement achieved by the invention, FIG. 5 shows the chromaticity uniformity in the light block of a mixed light beam projected onto a uniformly scattering white board as captured by a CCD camera, wherein the mixed light beam is emitted from a conventional primary light guide structure. FIG. 6 shows an image captured in a parallel experiment using a light beam mixed through the secondary light guide plate assembly according to the invention. It can be seen that a significant difference exists in the uniformity of these captured OUT images. Particularly, as shown in FIG. 7, upon taking two points toward both the left and right sides of the central point at the same distance in the horizontal direction of the respective captured images described above and denoting the central points as 100%, it can be found by comparing the two points on both the left and right sides that the variation in the uniformity of the conventional primary light guide structure is about ±13%, whereas the chromaticity uniformity in the image obtained according to the invention can be greatly improved to within ±2%. When 20 observation points are taken from the image in a vertical direction for measurement, the uniformity obtained by light mixing in the secondary light guide structure exceeds 98%, as shown in FIG. 8.

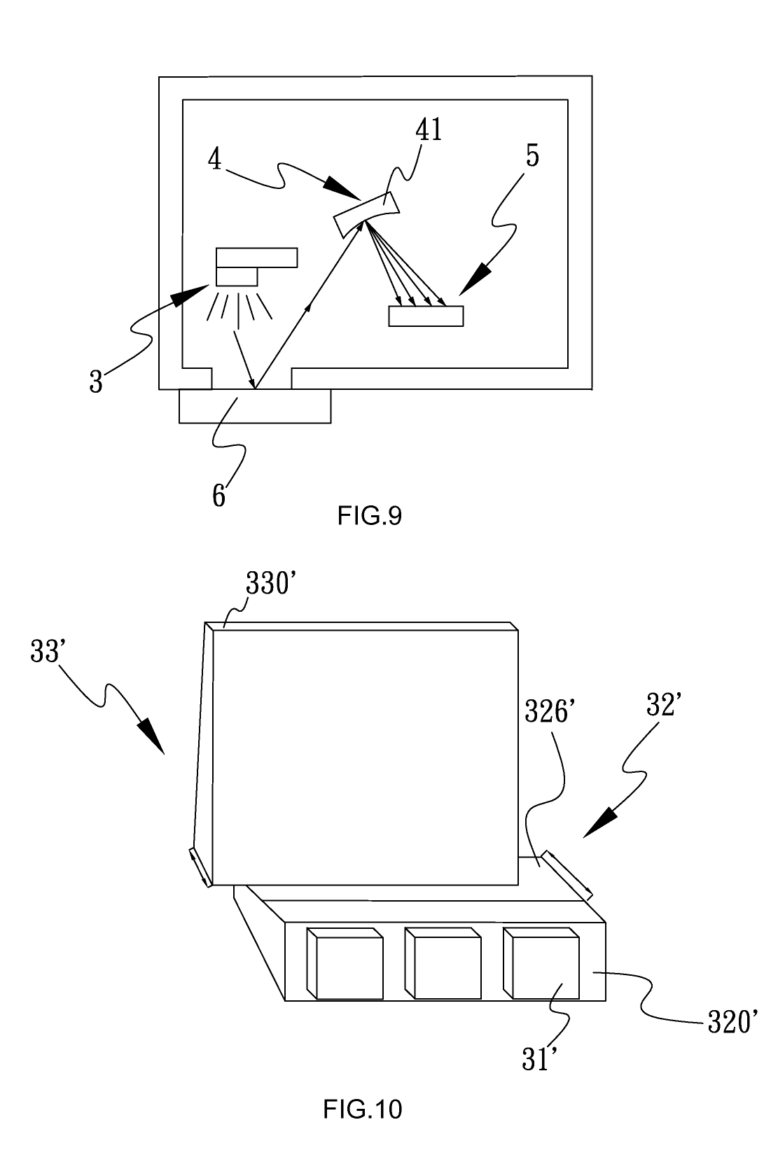

FIG. 9 shows a color sensor according to the first preferred embodiment of the invention, which comprises the light source 3 described above, a splitter device 4 and a sensor device 5. As described above, the luminance of the respective LED devices is based on the weighted value of the central wavelength thereof in the spectrum distribution of the standard illuminant D65. In this way, when the light source 3 conforming to the D65 standard illuminates the OUT 6, the respective wavelength components in the diffused light from the OUT 6 are separated by the splitter device 4, which is exemplified as a reflective grating 41. The angle of the reflective grating 41 is adjusted, so that a selected wavelength component is reflected to the sensor device 5. Afterwards, the angle is changed to measure stepwise the intensity of each of the split wavelength components, such that the sensor device 5 can precisely detect the respective reflection components diffused from the OUT 6.

It is apparent to those skilled in the art that some technical features described above, including those regarding the rectangular-shaped light guide plates, the primary light guide plate assembly formed by stacking multiple light guide plates, and the size of the light exit zone of the primary light guide plate assembly being exactly equal to that of the light entry face of the secondary light guide plate assembly, are all described for the purpose of illustration. According to the second preferred embodiment of the invention shown in FIG. 10, the light source comprises a primary light guide plate assembly 32′ that includes only one piece of downstream primary light guide plate 320′. The downstream primary light guide plate 320′, as well as secondary light guide plates 330′ in the secondary light guide plate assembly 33′, are of a wedge structure. The surface area of the light exit zone 326′ in the downstream primary light guide plate 320′ is slightly greater than the total surface area of the light entry faces in the secondary light guide plate assembly 33′, such that the light entry faces of the secondary light guide plate assembly 33′ cover the light exit zone 326′ of the downstream primary light guide plate up to a predetermined ratio. As a result, most of the exit light from the downstream primary light guide plate 320′ can enter into the secondary light guide plate assembly 33′ without significant loss.

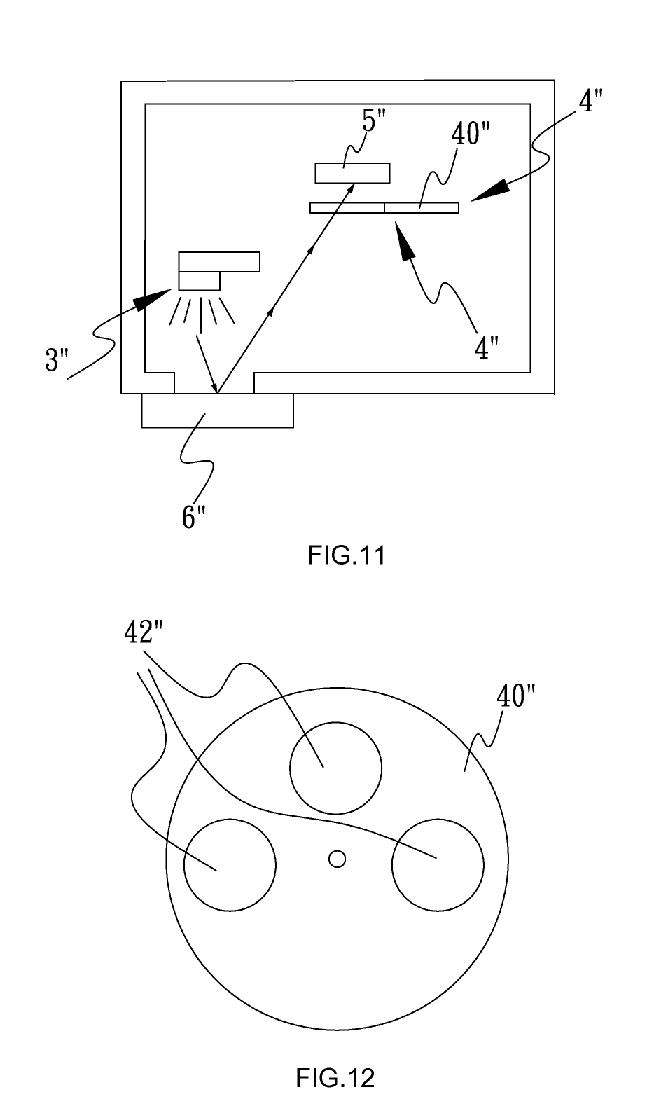

A second preferred embodiment for the color sensor according to the invention is shown in FIGS. 11 and 12, wherein the splitter device 4″ is a color filter wheel 40″ composed of multiple dichroic filters 42″. As the color filter wheel 40″ spins, the diffused reflection light generated by illumination from the light source 3″ to the OUT 6″ rotates along the time sequence of the color filter wheel 40″ and separated and filtered through three dichroic filters 42″ of red, blue and green colors, for example, and individually measured by the sensor device 5″ with regards to each different wavelength component.

Since the light source with uniform chromaticity and luminance according to the invention, as well as the color sensor provided with the same, adopt a combination of two light guide plate assemblies, the light beams emitted by respective LED devices are subject to a two-dimensional light mixing. That is, after the first light mixing by the primary light guide plate assembly, the uniformity of chromaticity and luminance may be still insufficient. It is proved herein that the second light mixing through the secondary light guide plate assembly significantly improves the insufficiency in chromaticity and luminance uniformity, thus allowing the mixed light of uniformized chromaticity and luminance to conform to the standard illuminant D65. As such, the color sensor according to the invention achieves a better precision and is more compact in size, thereby enabling a more convenient operation.

It should be noticed that, however, the illustrations set forth as above simply describe the preferred embodiments of the present invention which are not to be construed as restrictions for the scope of the present invention; contrarily, all effectively equivalent changes and modifications conveniently made in accordance with the claims and specifications disclosed in the present invention are deemed to be encompassed by the scope of the present invention delineated in the following claims.

What is claimed is:

1. A light source with uniform chromaticity and luminance, comprising:
a plurality of light emitting diode (LED) devices, having at least two mutually different central wavelengths;
a primary light guide plate assembly, including a downstream primary light guide plate having a light entry face and a light exit face adjacent to the light entry face, in which a light exit zone is formed on the light exit face of the downstream primary light guide plate; and
a secondary light guide plate assembly, including a plurality of mutually stacked secondary light guide plates, in which each of the secondary light guide plates has a light entry face and a light exit face adjacent to the light entry face, and the light entry faces of the secondary light guide plates exactly correspond to the light exit zone of the downstream primary light guide plate.

2. The light source with uniform chromaticity and luminance according to claim 1, wherein the light entry faces of the secondary light guide plates cover the light exit zone of the downstream primary light guide plate up to a predetermined ratio.

3. The light source with uniform chromaticity and luminance according to claim 2, wherein the light entry faces of the secondary light guide plates cover the light exit zone of the downstream primary light guide plate.

4. The light source with uniform chromaticity and luminance according to claim 1, wherein the light entry faces of the secondary light guide plates are arranged co-planar to one another.

5. The light source with uniform chromaticity and luminance according to claim 1, wherein the secondary light guide plates are cuboid-shaped and the surface area of the light entry faces is smaller than that of the light exit faces.

6. The light source with uniform chromaticity and luminance according to claim 1, wherein the primary light guide plate assembly further includes a plurality of upstream primary light guide plates overlapped with the downstream primary light guide plate, and wherein each of the upstream primary light guide plates has a light entry face and a light exit face arranged adjacent to the light entry face and disposed in a manner corresponding to the light exit face of the downstream primary light guide plate.

7. The light source with uniform chromaticity and luminance according to claim 6, wherein the light entry faces of the primary light guide plates are arranged co-planar with one another.

8. The light source with uniform chromaticity and luminance according to claim 1, wherein each of the respective LED devices has an emission central wavelength and provides a luminance based on the weighted value of the central wavelength in a spectrum distribution of the standard illuminant D65.

9. A color sensor provided with a light source with uniform chromaticity and luminance for measuring color components in a reflected light from an object under test (OUT) upon illumination, comprising:
a light source with uniform chromaticity and luminance, including:
a plurality of light emitting diode (LED) devices, having at least two mutually different central wavelengths;
a primary light guide plate assembly, including a downstream primary light guide plate having a light entry face and a light exit face adjacent to the light entry face, in which a light exit zone is formed on the light exit face of the downstream primary light guide plate; and
a secondary light guide plate assembly, including a plurality of mutually stacked secondary light guide plates, in which each of the secondary light guide plates has a light entry face and a light exit face adjacent to the light entry face, and the light entry faces of the secondary light guide plates exactly correspond to the light exit zone of the downstream primary light guide plate;
a splitter device for separating respective wavelength components in the light diffused from the OUT illuminated by the light source with uniform chromaticity and luminance; and
a sensor device for detecting the intensity of the respective wavelength components separated by the splitter device.

10. The color sensor according to claim 9, wherein the splitter device includes a reflective grating.

11. The color sensor according to claim 9, wherein the splitter device includes a dichroic filter.
